(19) United States
(12) Patent Application Publication
(10) Pub. No.: US 2009/0300027 A1
(43) Pub. Date: Dec. 3, 2009

(54) Database access server and database access system

(75) Inventors: Kosuke Matsunaga, Oita-shi (JP); Koki Togashi, Matsumoto-shi (JP); Eiichi Tokonami, Oita-shi (JP); Minoru Ichimura, Shiojiri-shi (JP)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: Seiko Epson Corporation, Tokyo (JP)

(21) Appl. No.: 12/454,893

(22) Filed: May 26, 2009

(30) Foreign Application Priority Data
May 26, 2008 (JP) 2008-136748

(51) Int. Cl. G06F 17/30

(52) U.S. Cl. 707/10; 707/E17.01; 707/E17.032

(57) ABSTRACT

A database access server that performs processing for making access to a database is provided. The database access server includes: a database access processing unit that performs processing for making access corresponding to a client access request, which indicates a request for making indirect access from a client to the database, to the database upon receiving the client access request, the database access processing unit performing the access processing by issuing a first database access request to the database and then issuing a second database access request to the database after the reception of a response to the first database access request; and a database access time measuring unit that measures access elapsed time from a point in time of the reception of the client access request, which is defined as access start time, to a predetermined processing point in time that is somewhere between the access start time and the issuance of the second database access request, wherein, if it is detected that the length of the access elapsed time measured by the database access time measuring unit is greater than, or is at least equal to, that of reference time, the database access processing unit cancels the execution of the second database access request.

### BACKGROUND

1. Technical Field

The present invention generally relates to a technique for preventing database access reliability from decreasing due to a delay in access processing. In particular, the invention relates to a technique for preventing database access reliability from decreasing when the processing of an access request issued to a database by a server that has now received a request for making indirect access from a client to the database does not proceed smoothly.

2. Related Art

A type of a client server system that allows a client to make access to a database indirectly via a server that is capable of making access to the database is known in the art. In such a type of a client server system, a client does not perform direct database access processing. Such a type of a client server system may be hereafter referred to as “database access system”. A server of the database access system that performs database access processing mentioned above may be hereafter referred to as “database access server”. An example of a database access system of the related art is described in, for example, JP-A-2003-87623, JP-A-2002-229943, and JP-A-9-319708.

A database access system of the related art has, for example, the following technical problem that remains to be solved. If processing for making access to a database is performed upon receiving a client access request issued by a client after a certain length of an access time interval, access processing that corresponds to the client access request may not proceed smoothly. For example, if processing for making access to a database is performed upon receiving a client access request issued by a client after an interval of a few hours, there might occur a substantial delay in access processing that corresponds to the client access request. If a database access server performs database access processing by issuing an access request to the database upon receiving the next client access request from the client during the unsmooth access processing that corresponds to the first client access request, the access processing that corresponds to the next client access request is performed without delay. On the other hand, the access processing that corresponds to the first client access request, which has been substantially delayed, is completed after the lapse of a certain time period, for example, after fifteen minutes. For this reason, if the database access server receives the next client access request from the client during the unsmooth access processing that corresponds to the first client access request, that is, during the substantial delay of the access processing that corresponds to the first client access request, the sequential order of access to the database for the first client access request and access to the database for the next client access request is undesirably reversed. As a result, database access reliability decreases.

### SUMMARY

An advantage of some aspects of the invention is to provide a technique for preventing database access reliability from decreasing due to a delay in access processing.

In order to address the above-identified problems without any limitation thereto, the invention provides, as various aspects thereof, a database access server, a database access system, an access method, a computer program, and a storage medium having the following novel and inventive features, the non-limiting exemplary configuration and operation of which will be described in detail below in

### DESCRIPTION OF EXEMPLARY EMBODIMENTS.

Application Example 1 (First Aspect): A database access server that performs processing for making access to a database, the database access server including: a database access processing section that performs processing for making access corresponding to a client access request, which indicates a request for making indirect access from a client to the database, to the database upon receiving the client access request, the database access processing section performing the access processing by issuing a first database access request to the database and then issuing a second database access request to the database after the reception of a response to the first database access request; and a database access time measuring section that measures access elapsed time from a point in time of the reception of the client access request, which is defined as access start time, to a predetermined processing point in time that is somewhere between the access start time and the issuance of the second database access request, wherein, if it is detected that the length of the access elapsed time measured by the database access time measuring section is greater than, or is at least equal to, that of reference time, the database access processing section cancels the execution of the second database access request.

A database access server according to the first aspect of the invention described above makes it possible to prevent database access reliability from decreasing due to a delay in access processing.

Application Example 2: In the configuration of a database access server according to the first aspect of the invention described above, it is preferable that the client access request should be a writing request issued for making access to the database; the first database access request should be a search request issued to the database; and the second database access request should be an actual writing request issued to the database.

With the preferred configuration of a database access server described above according to which the client access request is a writing request issued for making access to the database, the first database access request is a search request issued to the database, and the second database access request is an actual writing request issued to the database, it is possible to prevent database access reliability from decreasing due to a delay in access processing.

Application Example 3: In the configuration of a database access server according to the first aspect of the invention described above, it is preferable that, if it is detected that the length of the access elapsed time measured by the database access time measuring section is greater than, or is at least equal to, that of the reference time, the database access processing section should return a message that indicates that the client access request was aborted to the client as a response to the client access request.

With the preferred configuration of a database access server described above, for example, it is possible to allow the client to re-issue a client access request by sending a notification to the client to the effect that it is detected that the length of the access elapsed time measured by the database access time measuring section is greater than, or is at least equal to, that of the reference time. Therefore, it is possible to prevent database access reliability from decreasing due to a delay in access processing.

Application Example 4: In the preferred configuration of a database access server according to the application example 3 described above, it is further preferable that the reference time should be set so as to ensure that the message is returned before the occurrence of a timeout of the client access request at the client.

With the preferred configuration of a database access server according to the application example 4 described above, since the message that indicates that the client access request was aborted is returned before the occurrence of a timeout of the client access request at the client, it is possible to prevent database access reliability from decreasing due to a delay in access processing.

Application Example 5: In the configuration of a database access server according to the first aspect of the invention described above, it is preferable that the predetermined processing point in time should be a point in time of the reception of a response to the first database access request from the database.

With the preferred configuration of a database access server described above, it is possible to easily monitor the access elapsed time.

Application Example 6: In the configuration of a database access server according to the first aspect of the invention described above, it is preferable that the predetermined processing point in time should be a point in time that is immediately before the issuance of the second database access request to the database.

With the preferred configuration of a database access server described above, it is possible to easily monitor the access elapsed time.

It is not always necessary for a database access server according to an aspect of the invention described above should have all of features described above. That is, a database access server according to an aspect of the invention described above may be embodied with omission of some features thereof or combination thereof. The present invention can be actually implemented and/or embodied in a variety of modes. As a few non-limiting examples thereof, the invention can be actually implemented and/or embodied as, and/or in the form of, a database access server, an access method used by a database access server, a database access system, and an access method used by a database access system. Or, as another non-limiting examples thereof, the invention can be actually implemented and/or embodied as, and/or in the form of, a computer program that realizes functions made available by these apparatuses and/or methods, and/or a storage medium that stores such a computer program. The above description is provided as enumeration of examples of the invention implemented and/or embodied in various categories without any intention of limitation thereto. Various additional elements and/or features may be added to the concept of the present invention implemented and/or embodied in a variety of modes.

In a case where the invention is actually implemented and/or embodied as, and/or in the form of, a computer program and/or a storage medium that stores the computer program, the invention may constitute the entirety of a program that controls the operation of a data access server, or may constitute a part of a program that controls the operation of a data access server, where the part thereof realizes the characteristic functions of the invention. Various kinds of computer readable storage media are available for embodying the concept of the invention. For example, a storage medium according to an aspect of the invention may be a flexible disk/disc, a CD-ROM, a DVD-ROM, a magnet-optical disk/disc, an IC card, a ROM cartridge, a punch card, a printed matter on which a code such as a barcode or the like is printed, an internal storage unit of a computer (e.g., a memory such as a RAM, a ROM, or the like), an external storage unit of a computer, or the like.

### BRIEF DESCRIPTION OF THE DRAWINGS

The invention will be described with reference to the accompanying drawings, wherein like numbers reference like elements.

FIG. 1 is a diagram that schematically illustrates an example of the configuration of a database access system according to an exemplary embodiment of the invention.

FIG. 2 is a diagram that schematically illustrates the flow of access requested by a client and made to a database in the database access system according to an exemplary embodiment of the invention.

FIG. 3 is a sequence chart that schematically illustrates an example of access requested by the client and made to the database according to an exemplary embodiment of the invention, which is executed in accordance with the access flow illustrated in FIG. 2.

FIG. 4 is a sequence chart that schematically illustrates, as a comparative example, access requested by a client and made to a database.

### DESCRIPTION OF EXEMPLARY EMBODIMENTS

With reference to the accompanying drawings, exemplary embodiments of the invention are explained in the following two sections.

A. Exemplary Embodiment

B. Variation Example

### A. Exemplary Embodiment

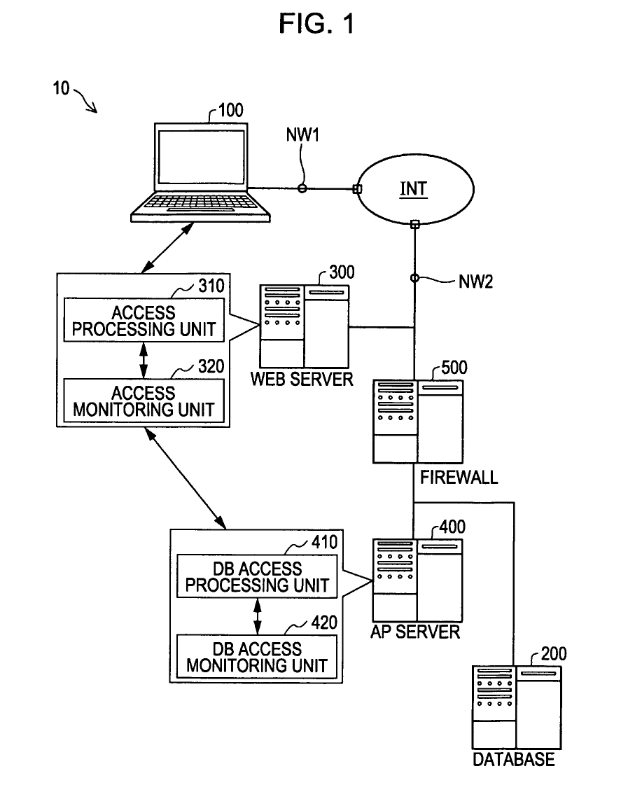

FIG. 1 is a diagram that schematically illustrates an example of the configuration of a database access system according to an exemplary embodiment of the invention. A database access system 10 includes a client-side network NW1 and a server-side network NW2 that are connected to each other via the Internet INT. A client 100 is provided as a network element of the client-side network NW1. A database 200 is provided as a network element of the server-side network NW2.

In the network composition of the server-side network NW2, a Web server 300, an application server 400, and the database 200 are provided as elements thereof with connection therebetween. The application server is hereafter abbreviated as “AP server”. A firewall 500 is provided between the Web server 300 and the database 200 as well as between the Web server 300 and the AP server 400. While permitting communication between the Web server 300 and the AP server 400, the firewall 500 functions to prohibit communication with other devices such as the client 100 and the like.

In the illustrated network example of the server-side network NW2, each of the Web server 300, the AP server 400, and the database 200 is configured as a single server/database. However, the network configuration of the server-side network NW2 is not limited thereto. It is possible to arbitrary set the number thereof for each of the Web server 300, the AP server 400, and the database 200.

Access to the database 200 by the client 100 is performed as follows. As a first step, the client 100 issues, not directly to the database 200 but to the Web server 300, a request for making access to the database 200 (e.g., a request for reading data out of the database 200, a request for writing data into the database 200, or the like). Upon receiving the request from the client 100, the Web server 300 transfers the received request to the AP server 400. In response to the received request, the AP server 400 issues a first database access request to the database 200. After the reception of a response to the first database access request, the AP server 400 makes a second database access request so as to carry out access and then respond to the Web server 300. The Web server 300 sends the access result received from the AP server 400 as a response to the client 100.

An access processing unit 310 and an access monitoring unit 320 principally perform the operation of the Web server 300 explained above. A database access processing unit 410 and a database access monitoring unit 420 principally perform the operation of the AP server 400 explained above. The term “database” may be hereafter abbreviated as “DB”. Accordingly, the database access processing unit 410 may be hereafter referred to as “DB access processing unit” 410. The database access monitoring unit 420 may be hereafter referred to as “DB access monitoring unit” 420.

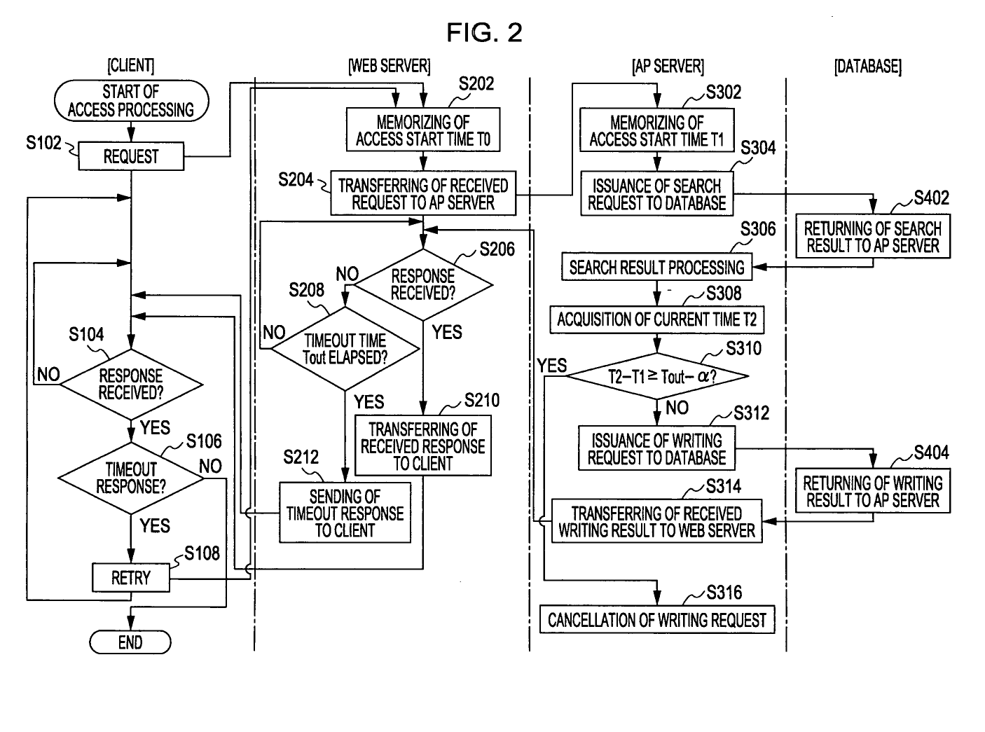

FIG. 2 is a diagram that schematically illustrates the flow of access requested by the client 100 and made to the database 200 in the database access system 10. In the illustrated example of FIG. 2, the client 100 requests the writing of data into the database 200 as the purpose (i.e., request item) of access requested by the client 100 and made to the database 200.

First of all, the flow of processing performed between the client 100 and the Web server 300 is explained below. The client 100 issues a data-writing request to the Web server 300 (step S102). Then, the client 100 waits in a standby state until a response to the request is returned from the Web server 300 (step S104).

Upon receiving the request issued by the client 100, the Web server 300 memorizes a point in time at which the Web server 300 received the request as access start time T0, which is the point in time of access start recognized and/or stored at the Web server 300 (step S202). Then, the Web server 300 transfers, as a notification, the request received from the client 100 to the AP server 400 (step S204). Thereafter, the Web server 300 waits in a standby state until either one of the following two conditions is satisfied; that is, the Web server 300 waits until a timeout time Tout has elapsed since the access start time T0 without receiving a response to the request from the AP server 400 or until the Web server 300 receives a response to the request from the AP server 400 (steps S206 and S208). If the Web server 300 receives a response to the request from the AP server 400, the Web server 300 transfers the received response to the client 100 (step S210). If the timeout occurs, the Web server 300 sends a response that indicates that the timeout has occurred (i.e., timeout response) to the client 100 (step S212).

Upon receiving the response from the Web server 300, the client 100 makes a judgment as to whether the received response is a reply to the request issued by the client 100 or a timeout response (step S106). If the received response is a reply to the request issued by the client 100, access processing ends. If the received response is a timeout response, the client 100 re-issues an access request, which may be hereafter referred to as “retry” request (step S108). Then, the client 100 waits in a standby state until a response to the retry request is returned from the Web server 300 (step S104).

Next, the flow of processing that is initiated between the AP server 400 and the database 200 when the request issued by the client 100 is notified from the Web server 300 to the AP server 400 is explained below. Upon receiving the request issued by the client 100 from the Web server 300, the AP server 400 memorizes a point in time at which the AP server 400 received the request as access start time T1, which is the point in time of access start recognized and/or stored at the AP server 400 (step S302). Then, the AP server 400 issues a search request to the database 200 (step S304). The search request described herein is a non-limiting example of a first database access request according to an aspect of the invention.

Upon receiving the search request, the database 200 performs database retrieval operation, and then returns the result of the search performed as a response to the AP server 400 (step S402).

Upon receiving the search result from the database 200, the AP server 400 performs various kinds of search-result processing on the basis of the result of the search (step S306). For example, the AP server 400 makes a judgment as to whether there is any available storage area in which the data can be written or not in this search-result processing step. Then, the AP server 400 acquires current time T2 at a point in time of the completion of the search-result processing (step S308). Next, the AP server 400 makes a judgment as to whether access elapsed time, which is calculated as the length of a time period from the access start time T1 to the current time T2, is not shorter than timeout time set at the AP server 400, which is calculated by subtracting a predetermined margin α from the timeout time Tout set at the Web server 300 (step S310). The access elapsed time may be hereafter denoted as “T2−T1” with parentheses. The timeout time set at the AP server 400 may be hereafter denoted as “Tout-α” with parentheses. If the value of the access elapsed time (T2−T1) is smaller than the value of the timeout time (Tout-α) set at the AP server 400, the AP server 400 issues a writing request to the database 200 (step S312). The writing request made by the AP server 400 described herein is a non-limiting example of a second database access request according to an aspect of the invention. If the value of the access elapsed time (T2−T1) is larger than or at least equal to the value of the timeout time (Tout-α) set at the AP server 400, the AP server 400 cancels the ongoing access request for writing data into the database 200 (step S316). Accordingly, an attempt for making access to the database 200 in response to the request issued by the client 100 is aborted.

Upon receiving the writing request, the database 200 performs writing operation (step S404). Then, the database 200 returns the writing result in the form of a response to the AP server 400.

Upon receiving the writing result from the database 200, the AP server 400 transfers the received writing result as a response to the Web server 300 (step S314). Upon receiving the writing result from the AP server 400, the Web server 300 returns, to the client 100, the received writing result as a reply to the request issued by the client 100 as explained earlier (step S210).

In the process of judging whether to cancel the request made to the database 200 for the writing processing, which is performed after the search processing, or not, the timeout time (Tout-α) is used at the AP server 400 as a basis of judgment according to the present embodiment of the invention. If the timeout time Tout is used here as a basis of judgment as done in the timeout judgment made at the Web server 300, the following problem arises. The access start time T1 stored at the AP server 400 is always later than the access start time T0 stored at the Web server 300. For this reason, if the access elapsed time (T2−T1) is compared with the timeout time Tout, there is a possibility that the AP server 400 recognizes that the processing should not be canceled even at, and after, a point in time where it is judged as timeout at the Web server 300. Therefore, it is preferable that the writing request should be canceled without exception at the AP server 400 whenever timeout is recognized at the Web server 300. For this reason, the timeout time is set at the AP server 400 at a value that is calculated by subtracting the predetermined margin α from the timeout time Tout set at the Web server 300.

The database access system 10 according to the present embodiment of the invention offers the following advantageous effects, which can be produced by carrying out access requested by the client 100 and made to the database 200 as explained above.

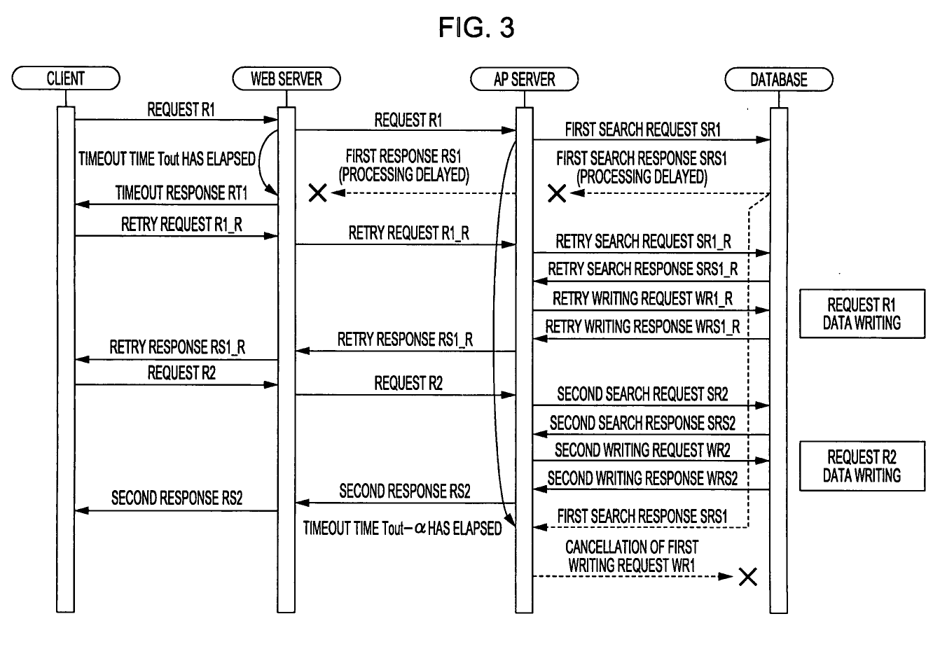

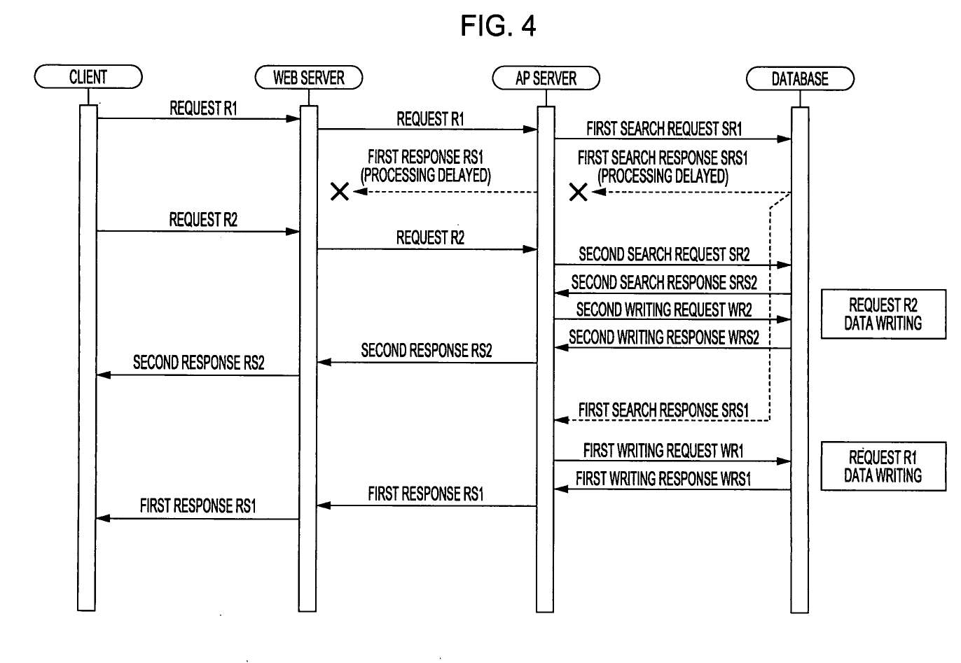

FIG. 3 is a sequence chart that schematically illustrates an example of access requested by the client 100 and made to the database 200 according to the present embodiment of the invention, which is executed in accordance with the access flow illustrated in FIG. 2. FIG. 4 is a sequence chart that schematically illustrates, as a comparative example, access requested by the client 100 and made to the database 200. In the comparative example illustrated in FIG. 4, the Web server 300 is not provided with the access monitoring unit 320 (refer to FIG. 1) unlike the Web-server configuration according to the present embodiment of the invention. Accordingly, in the Web-server operation of the comparative example, the timeout monitoring of the access monitoring unit 320 is not performed; in addition, the transmission of a timeout response to the client 100 by the access processing unit 310 is also not performed. In addition, in the comparative example illustrated in FIG. 4, the AP server 400 is not provided with the DB access monitoring unit 420 (refer to FIG. 1) unlike the AP-server configuration according to the present embodiment of the invention. Accordingly, in the AP-server operation of the comparative example, the timeout monitoring of the DB access monitoring unit 420 is not performed; in addition, the cancellation of a DB writing request, which is performed by the DB access processing unit 410 according to the present embodiment of the invention if necessary, is also not performed.

The operation sequence of the comparative example illustrated in FIG. 4 is explained first. The comparative example of FIG. 4 shows a case where two requests R1 and R2 that indicate requests for making writing access to the database 200 are sent from the client 100 to the Web server 300.

First, the client 100 sends the first request R1 to the Web server 300. The Web server 300 transfers the received first request R1 to the AP server 400. Upon receiving the first request R1 from the Web server 300, the AP server 400 sends a first search request SR1, which corresponds to the first request R1, to the database 200. In response to the received first search request SR1, the database 200 performs search processing. However, it is assumed herein that a first search response SRS1 is not returned immediately upon the prompt execution of the search processing corresponding to the first search request SR1. That is, it is assumed herein that the search processing is not performed smoothly, which means that there is a substantial delay therein. For this reason, a first response RS1, which is a reply to the first request R1, is not returned immediately from the AP server 400 to the Web server 300.

If timeout occurs at the client 100 for the first request R1 during the unsmooth processing explained above, the first request R1 is canceled. As a result of the cancellation of the first request R1, it becomes possible for the client 100 to issue the next request. Accordingly, the client 100 sends the second request R2 to the Web server 300. The Web server 300 transfers the received second request R2 to the AP server 400 as done in the transferring of the first request R1 explained above. Upon receiving the second request R2 from the Web server 300, the AP server 400 sends a second search request SR2, which corresponds to the second request R2, to the database 200 as done upon the reception of the first request R1 explained above. Unlike the foregoing case of the first search request SR1, the database 200 that has now received the second search request SR2 executes search processing corresponding to the second search request SR2 without delay. Then, the database 200 returns a second search response SRS2 corresponding thereto to the AP server 400. Upon receiving the second search response SRS2, the AP server 400 sends a second writing request WR2 corresponding to the second request R2 to the database 200. Upon receiving the second writing request WR2, the database 200 performs writing processing that corresponds to the second writing request WR2. Then, the database 200 sends a second writing response WRS2 back to the AP server 400. Upon receiving the second writing response WRS2, the AP server 400 returns a second response RS2, which is a reply to the second request R2, to the Web server 300. The Web server 300, which has now received the second response RS2, sends the received second response RS2 to the client 100.

On the other hand, the first search response SRS1 to the first search request SR1, the search processing of which did not proceed smoothly, is returned from the database 200 to the AP server 400 after the completion of writing processing that corresponds to the second writing request WR2. Upon receiving the first search response SRS1 after the substantial delay explained above, the AP server 400 sends a first writing request WR1 to the database 200. Upon receiving the first writing request WR1, the database 200 performs writing processing that corresponds to the first writing request WR1. Then, the database 200 sends a first writing response WRS1 back to the AP server 400. Upon receiving the first writing response WRS1, the AP server 400 returns the first response RS1, which is a reply to the first request R1, to the Web server 300. The Web server 300, which has now received the first response RS1, sends the received first response RS1 to the client 100.

As explained above, in the operation of the comparative example, the sequential order of the writing of data corresponding to the first request R1 into the database 200 and the writing of data corresponding to the second request R2 into the database 200 is reversed. That is, in the operation of the comparative example, the writing operation corresponding to the second request R2 is performed first, followed by the writing operation corresponding to the first request R1.

Next, the operation sequence according to the present embodiment of the invention, which is illustrated in FIG. 3, is explained below. As in the comparative example of FIG. 4, FIG. 3 shows a case where two requests R1 and R2 that indicate requests for making writing access to the database 200 are sent from the client 100 to the Web server 300.

First, as done in the comparative example explained above, the client 100 sends the first request R1 to the Web server 300. The Web server 300 transfers the received first request R1 to the AP server 400. Upon receiving the first request R1 from the Web server 300, the AP server 400 sends a first search request SR1, which corresponds to the first request R1, to the database 200. In response to the received first search request SR1, the database 200 performs search processing. However, as assumed in the comparative example explained above, it is assumed in the present embodiment described herein that a first search response SRS1 is not returned immediately upon the prompt execution of the search processing corresponding to the first search request SR1. That is, it is assumed herein that the search processing is not performed smoothly, which means that there is a substantial delay therein. For this reason, a first response RS1, which is a reply to the first request R1, is not returned immediately from the AP server 400 to the Web server 300.

The Web server 300 monitors elapsed time from the reception of the first request R1 to the reception of the first response RS1, which is a reply to the first request R1. If the processing corresponding to the first request R1 is not performed smoothly, resulting in that the elapsed time under monitoring exceeds the timeout time Tout due to the processing delay, the Web server 300 sends a timeout response RT1, as a response to the first request R1, back to the client 100. The timeout time Tout is set at such a value that ensures that the Web server 300 sends the timeout response RT1 to the first request R1 back to the client 100 before timeout occurs at the client 100, which means that the timeout response RT1 is returned before the first request R1 is aborted because of time restriction. Specifically, for example, the timeout time Tout is set at such a length that is slightly shorter than timeout time set at the client 100.

Upon receiving the timeout response RT1 from the Web server 300, the client 100 sends a retry request R1_R to the Web server 300. The retry request R1_R contains the same request information as that of the first request R1.

Upon receiving the retry request R1_R from the client 100, the Web server 300 transfers the received retry request R1_R to the AP server 400 as done in the transferring of the first request R1 explained above. Upon receiving the retry request R1_R from the Web server 300, the AP server 400 sends a retry search request SR1_R to the database 200 in the same manner as, or in a manner similar to, the issuance of the first search request SR1 corresponding to the first request R1 to the database 200. Unlike the foregoing case of the first search request SR1, the database 200 that has now received the retry search request SR1_R executes search processing corresponding to the retry search request SR1_R without delay. Then, the database 200 returns a retry search response SRS1_R corresponding thereto to the AP server 400. Upon receiving the retry search response SRS1_R, the AP server 400 sends a retry writing request WR1_R to the database 200. Upon receiving the retry writing request WR1_R, the database 200 performs writing processing that corresponds to the retry writing request WR1_R. Then, the database 200 sends a retry writing response WRS1_R back to the AP server 400. Upon receiving the retry writing response WRS1_R, the AP server 400 returns a retry response RS1_R, which is a reply to the retry request R1_R, to the Web server 300. The Web server 300, which has now received the retry response RS1_R, sends the received retry response RS1_R to the client 100. Then, it becomes possible for the client 100, which has now received the retry response RS1_R, to issue the next request.

Next, the client 100 sends the second request R2 to the Web server 300. The Web server 300 transfers the received second request R2 to the AP server 400 as done in the transferring of the first request R1 explained above. Upon receiving the second request R2 from the Web server 300, the AP server 400 sends the second search request SR2, which corresponds to the second request R2, to the database 200 as done upon the reception of the first request R1 explained above. Upon receiving the second search request SR2, the database 200 executes search processing corresponding to the second search request SR2. Then, the database 200 returns the second search response SRS2 corresponding thereto to the AP server 400. The AP server 400, which has now received the second search response SRS2, sends the second writing request WR2 to the database 200. Upon receiving the second writing request WR2, the database 200 performs writing processing that corresponds to the second writing request WR2. Then, the database 200 sends the second writing response WRS2 back to the AP server 400. Upon receiving the second writing response WRS2, the AP server 400 returns the second response RS2, which is a reply to the second request R2, to the Web server 300. The Web server 300, which has now received the second response RS2, sends the received second response RS2 to the client 100.

On the other hand, the first search response SRS1 to the first search request SR1, the search processing of which did not proceed smoothly, is returned from the database 200 to the AP server 400 after the completion of writing processing that corresponds to the second writing request WR2. At this point in the operation sequence, the AP server 400, which has received the first search response SRS1, makes a judgment as to whether the length of time lapsed [i.e., access elapsed time (T2−T1)] from the point in time of the reception of the first request R1 to the point in time of the completion of the search-result processing performed upon receiving the first search response SRS1 is greater than, or is at least equal to, the timeout time (Tout-α) set at the AP server 400. In other words, the AP server 400 judges whether the length of time lapsed from the point in time of the reception of the first request R1 to a point in time that is immediately before the issuance of the first writing request WR1 is greater than, or is at least equal to, the timeout time (Tout-α) set at the AP server 400. If the AP server 400 judges that the length of time lapsed is greater than, or is at least equal to, the timeout time (Tout-α) set at the AP server 400, the AP server 400 cancels the sending of the first writing request WR1 to the database 200. As a result, the access processing corresponding to the first request R1 is canceled.

As explained earlier, in the operation of the comparative example illustrated in FIG. 4, the sequential order of the writing of data into the database 200 is reversed if the second request R2 is issued during a time period in which the processing of the first search request SR1 corresponding to the first request R1 does not proceed smoothly. That is, a problem arises in that, if the second request R2 is issued during a time period in which the processing of the first search request SR1 corresponding to the first request R1 does not proceed smoothly, the writing of data corresponding to the second request R2 is performed first at the database 200, followed by the data-writing operation corresponding to the first request R1.

In contrast, in the operation according to the present embodiment of the invention, even when search processing and subsequent response to the first search request SR1, which corresponds to the first request R1, does not proceed smoothly, the Web server 300 monitors elapsed time from the reception of the first request R1 to the reception of the first response RS1, which is a reply to the first request R1; and, if the elapsed time under monitoring exceeds the timeout time Tout due to the processing delay, the Web server 300 sends the timeout response RT1, as a response to the first request R1, back to the client 100. This makes it possible for the client 100, which has now received the timeout response RT1 from the Web server 300, to send the retry request R1_R, which contains the same request information as that of the first request R1, to the Web server 300. Then, DB access processing corresponding to the retry request R1_R is performed without delay. As a result, it is possible to perform writing operation that actually corresponds to the first request R1.

In addition, when the first search response SRS1 that is supposed to be returned in response to the first search request SR1, which corresponds to the first request R1 whose processing did not go smoothly, is actually sent back from the database 200 to the AP server 400 after a substantial delay, the AP server 400 cancels the sending of the first writing request WR1 to the database 200 if the AP server 400 judges that the access elapsed time (T2−T1) is longer than, or is at least equal to, the timeout time (Tout-α) set at the AP server 400. Consequently, in such a case, it is possible to cancel the access processing that corresponds to the first request R1.

As explained in detail above, the Web server 300 monitors elapsed time from the reception of the first request R1 to the reception of the first response RS1, which is a reply to the first request R1 whose processing was not performed smoothly. If the elapsed time under monitoring exceeds the timeout time Tout due to the processing delay, the client 100 re-issues an access request for retry; and in addition thereto, the AP server 400 cancels the sending of a writing request corresponding to the delay-affected request to the database 200. By this means, it is possible to avoid the sequential order of the writing of data corresponding to the first request R1 into the database 200 and the writing of data corresponding to the second request R2 into the database 200 from being reversed.

A combination of the Web server 300 and the AP server 400 described in the present embodiment of the invention is a non-limiting example of a database access server according to an aspect of the invention. A combination of the access monitoring unit 320 and the DB access monitoring unit 420 described in the present embodiment of the invention is a non-limiting example of a database access time measuring section according to an aspect of the invention.

### B. Variation Example

Although exemplary embodiments of the present invention are described above, needless to say, the invention is in no case restricted to these exemplary embodiments described herein; the invention may be configured in an adaptable manner in a variety of variations and/or modifications without departing from the spirit thereof. Non-limiting variation examples thereof are explained below.

It is explained in the foregoing exemplary embodiments of the invention that the AP server 400 monitors, as the access elapsed time (T2−T1), time lapsed from a point in time of the reception of a request to a point in time of the completion of search-result processing performed upon receiving a search response returned in response to a search request. However, the scope of this aspect of the invention is not limited to such an exemplary configuration or exemplary operation. For example, the AP server 400 may monitor time lapsed from a point in time of the reception of a request to a point in time of the reception of a search response returned in response to a search request as the access elapsed time (T2−T1). That is, the AP server 400 may monitor the access elapsed time from the point in time of the reception of a request (i.e., access start time) to a certain processing point in time (i.e., timing), where certain processing point in time mentioned here is somewhere between the start of access (i.e., access start time) and the issuance of a writing request.

It is explained in the foregoing exemplary embodiments of the invention that a database access server according to an aspect of the invention is made up of two servers, or, more specifically, as a combination of the Web server 300 and the AP server 400. However, the scope of this aspect of the invention is not limited to such an exemplary configuration. For example, the database access server according to an aspect of the invention may be embodied as a single server.

It is explained in the foregoing exemplary embodiments of the invention that the client 100 requests the writing of data into the database 200 as the purpose of access requested by the client 100 and made to the database 200. In such exemplary operation, the AP server 400 issues a search request, which is an example of the first database access request according to an aspect of the invention, to the database 200. Then, the AP server 400 issues a writing request, which is an example of the second database access request according to an aspect of the invention, to the database 200. However, the scope of this aspect of the invention is not limited to such exemplary operation. For example, the client 100 may request the reading of data out of the database 200 as the purpose of access requested by the client 100 and made to the database 200. In such modified operation, the AP server 400 issues a search request, which is an example of the first database access request according to an aspect of the invention, to the database 200. Then, the AP server 400 issues a reading request, which is an example of the second database access request according to an aspect of the invention, to the database 200. That is, the concept of an aspect of the present invention can be applied to a wide variety of cases where processing is performed for making access corresponding to a client access request, which indicates a request for making indirect access from a client to a database, to the database upon receiving the client access request, where such access processing is performed by issuing a first database access request to the database and then issuing a second database access request to the database after the reception of a response to the first database access request.

What is claimed is:

1. A database access server that performs processing for making access to a database, the database access server comprising:
a database access processing section that performs processing for making access corresponding to a client access request, which indicates a request for making indirect access from a client to the database, to the database upon receiving the client access request, the database access processing section performing the access processing by issuing a first database access request to the database and then issuing a second database access request to the database after the reception of a response to the first database access request; and
a database access time measuring section that measures access elapsed time from a point in time of the reception of the client access request, which-is defined as access start time, to a predetermined processing point in time that is somewhere between the access start time and the issuance of the second database access request,
wherein, if it is detected that the length of the access elapsed time measured by the database access time measuring section is greater than, or is at least equal to, that of reference time, the database access processing section cancels the execution of the second database access request.

2. The database access server according to claim 1, wherein the client access request is a writing request issued for making access to the database; the first database access request is a search request issued to the database; and the second database access request is an actual writing request issued to the database.

3. The database access server according to claim 1, wherein, if it is detected that the length of the access elapsed time measured by the database access time measuring section is greater than, or is at least equal to, that of the reference time, the database access processing section returns a message that indicates that the client access request was aborted to the client as a response to the client access request.

4. The database access server according to claim 3, wherein the reference time is set so as to ensure that the message is returned before the occurrence of a timeout of the client access request at the client.

5. The database access server according to claim 1, wherein the predetermined processing point in time is a point in time of the reception of a response to the first database access request from the database.

6. The database access server according to claim 1, wherein the predetermined processing point in time is a point in time that is immediately before the issuance of the second database access request to the database.

7. A database access system comprising:
a client;
a database; and
a database access server that performs processing for making access corresponding to a client access request, which indicates a request for making indirect access from the client to the database, to the database upon receiving the client access request by issuing a first database access request to the database and then issuing a second database access request to the database after the reception of a response to the first database access request, and measures access elapsed time from a point in time of the reception of the client access request, which is defined as access start time, to a predetermined processing point in time that is somewhere between the access start time and the issuance of the second database access request,
wherein, if it is detected that the length of the access elapsed time is greater than, or is at least equal to, that of reference time, the execution of the second database access request is canceled.

8. The database access system according to claim 7, wherein, if it is detected that the length of the access elapsed time is greater than, or is at least equal to, that of the reference time, the database access server returns a message that indicates that the client access request was aborted to the client as a response to the client access request.

9. The database access system according to claim 8, wherein, the database access server includes a first server that receives the client access request and a second server that performs processing for making access to the database, and, if it is detected that the length of the access elapsed time is greater than, or is at least equal to, that of the reference time, the first server returns a message that indicates that the client access request was aborted to the client as a response to the client access request.

10. An access method used by a database access server that performs processing for making access to a database, the access method comprising:
performing processing for making access corresponding to a client access request, which indicates a request for making indirect access from a client to the database, to the database upon receiving the client access request by issuing a first database access request to the database and then issuing a second database access request to the database after the reception of a response to the first database access request; and
measuring access elapsed time from a point in time of the reception of the client access request, which is defined as access start time, to a predetermined processing point in time that is somewhere between the access start time and the issuance of the second database access request,
wherein the access processing includes, if it is detected in the time measurement that the length of the access elapsed time is greater than, or is at least equal to, that of reference time, canceling the execution of the second database access request.

11. An access method for making access to a database in a database access system that includes a client, a database access server, and the database, the access method comprising:
performing processing for making access corresponding to a client access request, which indicates a request for making indirect access from the client to the database, to the database upon receiving the client access request by issuing a first database access request to the database and then issuing a second database access request to the database after the reception of a response to the first database access request; and
measuring access elapsed time from a point in time of the reception of the client access request, which is defined as access start time, to a predetermined processing point in time that is somewhere between the access start time and the issuance of the second database access request,
wherein the access processing includes, if it is detected in the time measurement that the length of the access elapsed time is greater than, or is at least equal to, that of reference time, canceling the execution of the second database access request.

12. A computer program that is run for making access to a database, the computer program causing a computer to execute:
a function of performing processing for making access corresponding to a client access request, which indicates a request for making indirect access from a client to the database, to the database upon receiving the client access request by issuing a first database access request to the database and then issuing a second database access request to the database after the reception of a response to the first database access request;
a function of measuring access elapsed time from a point in time of the reception of the client access request, which is defined as access start time, to a predetermined processing point in time that is somewhere between the access start time and the issuance of the second database access request; and
a function of canceling, if it is detected that the length of the access elapsed time is greater than, or is at least equal to, that of reference time, the execution of the second database access request.

13. A computer readable storage medium that stores the computer program according to claim 12.
